(19) United States
(12) Patent Application Publication
(10) Pub. No.: US 2014/0090558 A1
(43) Pub. Date: Apr. 3, 2014

(54) ABSORPTION MEDIUM AND METHOD FOR ABSORPTION OF AN ACID GAS FROM A GAS MIXTURE

(71) Applicants: Jörn Rolker, Alzenau (DE); Matthias Seiler, Griesheim (DE); Rolf Schneider, Grundau-Rothenbergen (DE); Thibaut Lenormant, Frankfurt am Main (DE)

(72) Inventors: Jörn Rolker, Alzenau (DE); Matthias Seiler, Griesheim (DE); Rolf Schneider, Grundau-Rothenbergen (DE); Thibaut Lenormant, Frankfurt am Main (DE)

(73) Assignee: Evonik Degussa GmbH, Essen (DE)

(21) Appl. No.: 14/124,472

(22) PCT Filed: May 25, 2012
(86) PCT No.: PCT/EP2012/059824

§ 371 Date: Dec. 6, 2013

(30) Foreign Application Priority Data
Jun. 10, 2011 (EP) 11169492.3

(51) Int. Cl. B01D 53/14

(52) U.S. Cl. CPC B01D 53/1493; B01D 53/14; B01D 53/1425; B01D 53/1475
USPC 95/161; 95/236; 95/174; 95/179; 95/166; 95/163; 95/177; 252/189

(57) ABSTRACT

An absorption medium which comprises water, an amine (A) of formula (I)

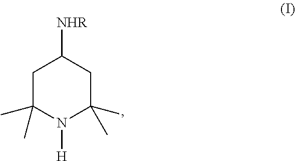

in which R is an n-alkyl radical having 1 to 4 carbon atoms, and an alkanolamine (B) which is a tertiary amine or a sterically hindered primary or secondary amine has a high absorption capacity for CO₂ with a high absorption rate. In the absorption of acid gases from a gas mixture a separation of the absorption medium into two liquid phases or the precipitation of a solid upon absorption of CO₂ and regeneration of the absorption medium can be avoided with the absorption medium, even without addition of a solvent.

The invention relates to an absorption medium and to a method for absorbing an acid gas, more particularly CO₂, from a gas mixture.

In many industrial and chemical operations there are gas streams which contain an unwanted amount of acid gases, more particularly CO₂, the amount of which must be reduced for further processing, for transportation or for the prevention of CO₂ emissions.

On the industrial scale, CO₂ is typically absorbed from a gas mixture by using aqueous solutions of alkanolamines as an absorption medium. The loaded absorption medium is regenerated by heating, depressurization to a lower pressure or stripping, and the carbon dioxide is desorbed. After the regeneration process, the absorption medium can be used again. These methods are described for example in Rolker, J.; Arlt, W.; “Abtrennung von Kohlendioxid aus Rauchgasen mittels Absorption” [Removal of carbon dioxide from flue gases by absorption] in Chemie Ingenieur Technik 2006, 78, pages 416 to 424, and also in Kohl, A. L.; Nielsen, R. B., “Gas Purification”, 5th edition, Gulf Publishing, Houston 1997.

A disadvantage of these methods, however, is that the removal of CO₂ by absorption and subsequent desorption requires a relatively large amount of energy and that, on desorption, only a part of the absorbed CO₂ is desorbed again, with the consequence that, in a cycle of absorption and desorption, the capacity of the absorption medium is not sufficient.

U.S. Pat. No. 7,419,646 describes a process for deacidifying off-gases in which an absorption medium is used which forms two separable phases upon absorption of the acid gas. 4-Amino-2,2,6,6-tetramethylpiperidine is cited, inter alia, in column 6 as a reactive compound for absorbing an acid gas. The process of U.S. Pat. No. 7,419,646 has the disadvantage that additional apparatus is required for separating the two phases which arise in the absorption.

US 2009/0199709 describes a similar method, in which, following absorption of the acid gas, heating of the loaded absorption medium produces two separable phases which are then separated from one another. Here again, 4-amino-2,2,6,6-tetramethylpiperidine is cited among others as a reactive compound suitable for the absorption of an acid gas.

FR 2900841 and US 2007/0286783 describe methods for deacidifying off-gases, in which the reactive compound reacted with CO₂ is separated from the loaded absorption medium by extraction. One of the reactive compounds cited for the absorption of an acid gas is 4-amino-2,2,6,6-tetra-methylpiperidine.

WO 2010/089257 describes an absorption medium for absorbing CO₂ from a gas mixture that comprises water and a 4-amino-2,2,6,6-tetramethylpiperidine, which amine can be alkylated on the 4-amino group. With absorption media comprising 4-amino-2,2,6,6-tetramethylpiperidine as absorbent, however, the absorption of CO₂ is readily accompanied by precipitation of the carbamate salt. WO 2010/089257 describes the addition of solvents, such as sulfolane or ionic liquids, in order to maintain the absorption medium single phase and to achieve a higher absorption capacity for CO₂.

Therefore, there is still a need for an absorption medium for CO₂ which at the same time features a high absorption capacity for CO₂ with a high absorption rate and with which it is possible, even without addition of a solvent, to prevent separation into two liquid phases or precipitation of a solid during the absorption of CO₂ and the regeneration of the absorption medium.

It has now been found that this object can be achieved by an absorption medium which comprises a 4-amino-2,2,6,6-tetramethylpiperidine having an n-alkyl substituent on the 4-amino group, and also a tertiary or a sterically hindered primary or secondary alkanolamine.

The invention accordingly provides an absorption medium for absorbing an acid gas from a gas mixture, comprising water, an amine (A) of formula (I)

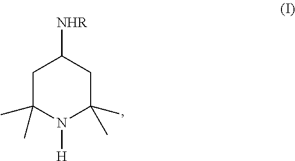

in which R is an n-alkyl radical having 1 to 4 carbon atoms, and an alkanolamine (B) which is a tertiary amine or a sterically hindered primary or secondary amine.

The invention additionally provides a method for absorbing an acid gas from a gas mixture by contacting the gas mixture with the absorption medium of the invention.

The absorption medium of the invention comprises water and an amine (A) of formula (I), where R is an n-alkyl radical having 1 to 4 carbon atoms. R can thus be a methyl radical, an ethyl radical, an n-propyl radical or an n-butyl radical. Preferably R is an n-propyl radical or an n-butyl radical, more preferably an n-butyl radical. Amines of formula (I) can be prepared from commercial triacetone amine by reductive amination, i.e. by reacting triacetone amine with an amine of formula RNH₂ and hydrogen in the presence of a hydrogenation catalyst.

The absorption medium of the invention further comprises an alkanolamine (B) which is a tertiary amine or a sterically hindered primary or secondary amine. A sterically hindered primary amine for the purposes of the invention is a primary amine in which the amino group is attached to a tertiary carbon atom, i.e. to a carbon atom to which no hydrogen atom is attached. A sterically hindered secondary amine for the purposes of the invention is a secondary amine in which the amino group is attached to a secondary or a tertiary carbon atom, i.e. to a carbon atom to which only one or no hydrogen atom is attached.

Suitable alkanolamines (B) having a tertiary amino group are triethanolamine, N-methyldiethanolamine, N,N-dimethylethanolamine, triisopropanolamine, N-methyldiisopropanolamine, N,N-dimethylisopropanolamine, N,N-dimethylaminoethoxyethanol, N,N-bis(3-dimethyl-aminopropyl)-N-ethanolamine, N-(3-dimethylamino-propyl)-N,N-diethanolamine, N,N-bis(3-dimethylamino-propyl)-N-isopropanolamine, N-(3-dimethylamino-propyl)-N,N-diisopropanolamine, N-hydroxyethylpiperidine, N-hydroxyethylmorpholine and N,N′-bis(hydroxy-ethyl)piperazine. A preferred alkanolamine (B) having a tertiary amino group is N-methyldiethanolamine.

Suitable alkanolamines (B) having a sterically hindered primary or secondary amino group are known from U.S. Pat. No. 4,094,957 columns 10 to 16. Preferred alkanolamines (B) having a sterically hindered primary amino group are 2-amino-2-methyl-1-propanol, 2-amino-2-methyl-1-butanol and 2-amino-2-methyl-3-pentanol. Particular preference is given to 2-amino-2-methyl-1-propanol.

In the absorption medium of the invention the amount of amines (A) of formula (I) is preferably in the range from 5% to 50% by weight and the amount of alkanolamines (B) is preferably in the range from 5% to 50% by weight. More preferably the amount of amines (A) of formula (I) is in the range from 5% to 30% by weight and the amount of alkanolamines (B) is preferably in the range from 5% to 30% by weight. The total amount of amines (A) of formula (I) and of alkanolamines (B) in the absorption medium of the invention is preferably in the range from 10% to 60% by weight, more preferably in the range from 10% to 45% by weight and most preferably in the range from 10% to 30% by weight.

The absorption capacity for CO₂ of the absorption media of the invention is high, and is generally higher than that to be expected on the basis of the absorption capacities of absorption media containing only an amine (A) of the formula (I) or only an alkanolamine (B). At the same time, the absorption media of the invention exhibit sufficiently high absorption rates for technical application. Even without addition of a solvent, the absorption media of the invention do not exhibit any precipitation of a solid upon absorption of CO₂.

In addition to water, amines (A) of formula (I) and alkanolamines (B), the absorption medium of the invention may further comprise one or more physical solvents (C). The fraction of physical solvents (C) in this case may be up to 50% by weight. Suitable physical solvents (C) include sulfolane, aliphatic acid amides, such as N-formyl-morpholine, N-acetylmorpholine, N-alkylpyrrolidones, more particularly N-methyl-2-pyrrolidone, or N-alkylpiperidones, and also diethylene glycol, triethylene glycol and polyethylene glycols and alkyl ethers thereof, more particularly diethylene glycol monobutyl ether. Preferably, however, the absorption medium of the invention contains no physical solvent (C).

The absorption medium of the invention may additionally comprise further additives, such as corrosion inhibitors, wetting-promoting additives and defoamers.

All compounds known to the skilled person as suitable corrosion inhibitors for the absorption of CO₂ using alkanolamines can be used as corrosion inhibitors in the absorption medium of the invention, in particular the corrosion inhibitors described in U.S. Pat. No. 4,714,597. With an absorption medium of the invention, a significantly lower amount of corrosion inhibitors can be chosen than in the case of a customary absorption medium comprising ethanolamine, since the absorption media of the invention are significantly less corrosive towards metallic materials than the customarily used absorption media that contain ethanolamine.

The cationic surfactants, zwitterionic surfactants and nonionic surfactants known from WO 2010/089257 page 11, line 18 to page 13, line 7 are preferably used as wetting-promoting additive.

All compounds known to the skilled person as suitable defoamers for the absorption of CO₂ using alkanolamines can be used as defoamers in the absorption medium of the invention.

In the method of the invention for absorbing an acid gas from a gas mixture, the gas mixture is contacted with the absorption medium of the invention.

The acid gas may be, for example, CO₂, COS, H₂S, CH₃SH or SO₂. The gas mixture may also comprise two or more of these acid gases at the same time. The gas mixture preferably comprises CO₂ and/or H₂S as acid gas, more preferably CO₂.

The gas mixture may be a natural gas, a methane-containing biogas from a fermentation, composting or a sewage treatment plant, a combustion off-gas, an off-gas from a calcination reaction, such as the burning of lime or the production of cement, a residual gas from a blast-furnace operation for producing iron, or a gas mixture resulting from a chemical reaction, such as, for example, a synthesis gas comprising carbon monoxide and hydrogen, or a reaction gas from a steam-reforming hydrogen production process. The gas mixture is preferably a synthesis gas, a natural gas or a combustion off-gas.

Prior to contacting with the absorption medium, the gas mixture preferably has a CO₂ content in the range from 0.1% to 60% by volume, more preferably in the range from 1% to 40% by volume.

For the method of the invention, all apparatus suitable for contacting a gas phase with a liquid phase can be used to contact the gas mixture with the absorption medium. Preferably, absorption columns or gas scrubbers known from the prior art are used, for example membrane contactors, radial flow scrubbers, jet scrubbers, venturi scrubbers, rotary spray scrubbers, random packing columns, ordered packing columns or tray columns. With particular preference, absorption columns are used in countercurrent flow mode.

In the method of the invention, the absorption of the acid gas is carried out preferably at a temperature of the absorption medium in the range from 10 to 80° C., more preferably 20 to 60° C. When using an absorption column in countercurrent flow mode, the temperature of the absorption medium is more preferably 30 to 60° C. on entry into the column, and 35 to 70° C. on exit from the column.

The absorption of the acid gas is carried out preferably at a pressure of the gas mixture in the range from 0.5 to 90 bar, more preferably 0.9 to 30 bar. For absorption of CO₂, the pressure of the gas mixture is preferably selected such that the partial pressure of CO₂ in the gas mixture before the absorption is in the range from 0.1 to 10 bar. Absorption of CO₂ from synthesis gas is carried out preferably at a pressure of the gas mixture in the range from 1 to 90 bar, more preferably 5 to 60 bar. Absorption of CO₂ from natural gas is carried out preferably at a pressure of the gas mixture in the range from 5 to 90 bar, more preferably 10 to 80 bar. Absorption of CO₂ from a combustion off-gas is carried out preferably at a pressure of the gas mixture in the range from 0.8 to 1.5 bar, more preferably 0.9 to 1.1 bar, so that the combustion off-gas does not have to be compressed beforehand.

In a preferred embodiment of the method of the invention, the acid gas is CO₂, and CO₂ absorbed in the absorption medium is desorbed again by an increase in temperature and/or a reduction in pressure, and the absorption medium, after this desorption of CO₂, is reused for absorbing CO₂. By such cyclic operation of absorption and desorption, CO₂ can be entirely or partially separated from the gas mixture and obtained separately from other components of the gas mixture.

As an alternative to the increase in temperature or the reduction in pressure, or in addition to an increase in temperature and/or a reduction in pressure, it is also possible to carry out a desorption by stripping the CO₂-loaded absorption medium with a gas.

If, in the desorption of CO₂, water is also removed from the absorption medium, water may be added as necessary to the absorption medium before reuse for absorption.

All apparatus known from the prior art for desorbing a gas from a liquid can be used for the desorption. The desorption is preferably carried out in a desorption column. Alternatively, the desorption of CO₂ may also be carried out in one or more flash evaporation stages.

The desorption is carried out preferably at a temperature in the range from 30 to 180° C. In a desorption by an increase in temperature, the desorption of CO₂ is carried out preferably at a temperature of the absorption medium in the range from 50 to 180° C., more preferably 80 to 150° C. The temperature during desorption is then preferably at least 20° C., more preferably at least 50° C., above the temperature during absorption.

In a desorption by a reduction in pressure, the desorption of CO₂ is carried out preferably at a total pressure in the gas phase in the range from 0.01 to 10 bar, more particularly 0.1 to 5 bar. The pressure during desorption is then preferably at least 1.5 bar, more preferably at least 4 bar, below the pressure during absorption, and most preferably is at atmospheric pressure.

Since the absorption medium of the invention has a high absorption capacity for CO₂ with a high absorption rate and is present as a homogeneous solution in the method of the invention, the method of the invention can be used in plants which are of simple construction, of the kind used in the prior art for gas scrubbing using aqueous solutions of ethanolamine, and in this case achieves an absorption performance for CO₂ that is improved in comparison to ethanolamine. At the same time, in comparison to ethanolamine, substantially less energy is required for the desorption of CO₂.

In a preferred embodiment of the method of the invention, the desorption takes place at first by pressure reduction in one or more successive flash evaporation stages, followed by stripping with an inert gas, such as air or nitrogen, in a desorption column. In the final flash evaporation stages, the pressure is lowered preferably to 1 to 5 bar, more preferably to 1 to 2 bar. Stripping in the desorption column takes place preferably at a temperature of the absorption medium in the range from 60 to 100° C. Through the combination of flash evaporation and stripping it is possible to achieve a low residual CO₂ content in the absorption medium after desorption with low energy demand.

In this way, the amount of absorption medium required in the overall operation can be lowered, and the thermal energy demand for the desorption of CO₂ can be reduced.

The examples below illustrate the invention without, however, restricting the subject matter of the invention.

### EXAMPLES

The absorption media investigated are summarized in Table 1.

For determining the CO₂ loading, the CO₂ uptake and the relative absorption rate, 150 g of absorption medium were charged to a thermostatable container with a top-mounted reflux condenser cooled at 3° C. After heating to 40° C. or 100° C., a gas mixture of 14% CO₂, 80% nitrogen and 6% oxygen by volume was passed at a flow rate of 59 l/h through the absorption medium, via a frit at the bottom of the container, and the CO₂ concentration in the gas stream leaving the reflux condenser was determined by IR absorption using a CO₂ analyser. The difference between the CO₂ content in the gas stream introduced and in the exiting gas stream was integrated to give the amount of CO₂ taken up, and the equilibrium CO₂ loading of the absorption medium was calculated. The CO₂ uptake was calculated as the difference in the amounts of CO₂ taken up at 40° C. and at 100° C. From the slope of the curve of CO₂ concentration in the exiting gas stream for an increase in concentration from 1% to 12% by volume, a relative absorption rate of CO₂ in the absorption medium was determined. The equilibrium loadings determined in this way at 40° C. and 100° C., in mol CO₂/mol amine, the CO₂ uptake in mol CO₂/kg absorption medium, and the relative absorption rate of CO₂, relative to Example 1 with 100%, are given in Table 1.

The absorption media of the invention achieve a better CO₂ uptake than is expected on the basis of the fractions of the two amines and their CO₂ uptake. The absorption media comprising AMP in fact exhibit a significantly better CO₂ uptake than when using the individual amines. The non-inventive absorption media of Examples 5, 9 and 13, which in addition to an amine (A) of formula (I) contain ethanolamine, a primary alkanolamine without steric hindrance, in contrast, exhibit a poorer CO₂ uptake than is expected on the basis of the fractions of the two amines and their CO₂ uptake.

TABLE 1

| | Example | | | | | | | | | | |
|---|---|---|---|---|---|---|---|---|---|---|---|
| | 1* | 2* | 3* | 4* | 5* | 6 | 7 | 8* | 9* | 10 | 11 |
| Fractions in % by weight | | | | | | | | | | | |
| Water | 70 | 70 | 70 | 70 | 70 | 70 | 70 | 70 | 70 | 70 | 70 |
| MEA | 30 | 0 | 0 | 0 | 20 | 0 | 0 | 0 | 20 | 0 | 0 |
| MDEA | 0 | 30 | 0 | 0 | 0 | 20 | 0 | 0 | 0 | 20 | 0 |
| AMP | 0 | 0 | 30 | 0 | 0 | 0 | 20 | 0 | 0 | 0 | 20 |
| Me-TAD | 0 | 0 | 0 | 30 | 10 | 10 | 10 | 0 | 0 | 0 | 0 |
| Pr-TAD | 0 | 0 | 0 | 0 | 0 | 0 | 0 | 30 | 10 | 10 | 10 |
| Bu-TAD | 0 | 0 | 0 | 0 | 0 | 0 | 0 | 0 | 0 | 0 | 0 |
| Loading at 40° C. in mol/mol | 0.45 | 0.38 | 0.55 | ** | 0.68 | 0.76 | 0.96 | 1.53 | 0.73 | 0.70 | 0.89 |
| Loading at 100° C. in mol/mol | 0.22 | 0.05 | 0.09 | ** | 0.43 | 0.20 | 0.23 | 0.39 | 0.44 | 0.14 | 0.16 |
| CO₂ uptake in mol/kg | 1.15 | 0.83 | 1.55 | ** | 0.96 | 1.27 | 2.08 | 1.71 | 1.09 | 1.22 | 1.99 |
| Relative absorption rate in % | 100 | 3 | 31 | ** | 75 | 58 | 31 | 41 | 94 | 79 | 55 |

| | Example | | | |
|---|---|---|---|---|
| | 12* | 13* | 14 | 15 |
| Fractions in % by weight | | | | |
| Water | 70 | 70 | 70 | 70 |
| MEA | 0 | 20 | 0 | 0 |
| MDEA | 0 | 0 | 20 | 0 |
| AMP | 0 | 0 | 0 | 20 |
| Me-TAD | 0 | 0 | 0 | 0 |
| Pr-TAD | 0 | 0 | 0 | 0 |
| Bu-TAD | 30 | 10 | 10 | 10 |
| Loading at 40° C. in mol/mol | 1.38 | 0.75 | 0.69 | 0.84 |
| Loading at 100° C. in mol/mol | 0.20 | 0.44 | 0.13 | 0.18 |
| CO₂ uptake in mol/kg | 1.66 | 1.16 | 1.21 | 1.80 |
| Relative absorption rate in % | 50 | 116 | 57 | 44 |

*not inventive
**solid precipitated upon introduction of gas
MEA: Ethanolamine
MDEA: N-Methyldiethanolamine
AMP: 2-Amino-2-methyl-l-propanol
Me-TAD: 4-Methylamino-2,2,6,6-tetramethylpiperidine
Pr-TAD: 4-(n-Propylamino)-2,2,6,6-tetramethylpiperidine
Bu-TAD: 4-(n-Butylamino)-2,2,6,6-tetramethylpiperidine

For the absorption media of Examples 4 to 15, the temperature at which phase separation of the CO₂-loaded and CO₂-free absorption medium occurs upon heating was also determined. For loading with CO₂, the absorption medium was saturated with pure CO₂ at 1 bar and 20° C. before the glass container was closed. The absorption medium was then heated slowly in a closed, pressure-rated glass container until a clouding or separation into two liquid phases was discernible. The phase separation temperatures determined in this way are listed in Table 2. An entry marked with the symbol > means that up to that temperature there was no separation and that the experiment was ended at the temperature indicated, for safety reasons.

The data in Table 2 shows that the absorption media of the invention, in comparison to absorption media containing only amine (A) of formula (I), exhibit significantly higher phase separation temperatures and no precipitation of solid upon loading with CO₂.

TABLE 2

| | Phase separation | |
|---|---|---|
| | temperature | Phase separation |
| | CO₂-loaded | temperature without CO₂ |
| Example | in ° C. | in ° C. |
| 4* | ** | >120 |
| 5* | >120 | >120 |
| 6 | >120 | >120 |
| 7 | >120 | >120 |
| 8* | ** | 70 |
| 9* | >120 | >120 |
| 10 | >110 | 100 |
| 11 | >110 | 100 |
| 12* | 90 | 45 |
| 13* | >125 | 82 |
| 14 | >125 | 75 |
| 15 | 112 | 95 |

*not inventive
** solid precipitated upon loading with CO₂

1-14. (canceled)

15. An absorption medium for absorbing an acid gas from a gas mixture, comprising:
a) water;
b) an amine (A) of formula (I): 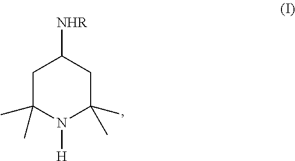
in which R is an n-alkyl radical having 1 to 4 carbon atoms; and
c) an alkanolamine (B) which is a tertiary amine or a sterically hindered primary or secondary amine.

16. The absorption medium of claim 15, wherein the alkanolamine (B) is N-methyl-diethanolamine.

17. The absorption medium of claim 15, wherein the alkanolamine (B) is 2-amino-2-methyl-1-propanol.

18. The absorption medium of claim 15, wherein, in formula (I), R is an n-propyl radical or an n-butyl radical.

19. The absorption medium of claim 18, wherein the alkanolamine (B) is 2-amino-2-methyl-1-propanol or N-methyldiethanolamine.

20. The absorption medium of claim 19, wherein the amount of amines (A) of formula (I) is in the range from 5% to 50% by weight and the amount of alkanolamines (B) is in the range from 5% to 50% by weight.

21. The absorption medium of claim 19, wherein the total amount of amines (A) of formula (I) and of alkanolamines (B) is in the range from 10% to 60% by weight.

22. The absorption medium of claim 15, wherein the total amount of amines (A) of formula (I) and of alkanolamines (B) is in the range from 10% to 60% by weight.

23. The absorption medium of claim 15, wherein the amount of amines (A) of formula (I) is in the range from 5% to 50% by weight and the amount of alkanolamines (B) is in the range from 5% to 50% by weight.

24. A method for absorbing an acid gas from a gas mixture, comprising contacting the gas mixture with the absorption medium of claim 15.

25. The method of claim 24, wherein the gas mixture is a synthesis gas, a natural gas or a combustion off-gas.

26. The method of claim 24, wherein the gas mixture is contacted with the absorption medium at a pressure in the range of from 0.5 to 90 bar.

27. The method of 24, wherein the acid gas is CO₂.

28. The method of claim 27, wherein the gas mixture has an initial CO₂ content in the range of from 0.1% to 60% by volume.

29. The method of claim 27, wherein CO₂ absorbed in the absorption medium is desorbed by an increase in temperature and/or a reduction in pressure, and the absorption medium, after this desorption of CO₂, is reused for absorbing CO₂.

30. The method of claim 29, wherein the absorption is carried out at a temperature in the range of from 10 to 80° C. and the desorption is carried out at a temperature in the range of from 30 to 180° C.

31. The method of claim 29, wherein the absorption medium loaded with CO₂ is stripped with an inert gas for desorption.

32. The method of claim 24, wherein the alkanolamine (B) in the absorption medium is either 2-amino-2-methyl-1-propanol or N-methyldiethanolamine.

33. The method of claim 32, wherein, in formula (I) in the absorption medium, R is an n-propyl radical or an n-butyl radical.

34. The method of claim 33, wherein the gas mixture is contacted with the absorption medium at a pressure in the range of from 0.5 to 90 bar and the acid gas is CO₂.
